(19) United States
(12) Patent Application Publication
(10) Pub. No.: US 2018/0310567 A1
(43) Pub. Date: Nov. 1, 2018

(54) NON-HAZARDOUS BIO-PESTICIDE/NEMATICIDE

(71) Applicant: PRONUTECH, INC., Winchester, KY (US)

(72) Inventor: James G. Criggall, Winchester, KY (US)

(21) Appl. No.: 15/964,990

(22) Filed: Apr. 27, 2018

Related U.S. Application Data
(60) Provisional application No. 62/492,515, filed on May 1, 2017.

(51) Int. Cl. A01N 59/06; A01N 25/10; C05G 3/02; C05F 11/00

(52) U.S. Cl. CPC A01N 59/06; C05F 11/00; C05G 3/02; A01N 25/10

(57) ABSTRACT

A non-hazardous bio-pesticide, nematicide, and plant nutrient composition includes a mechanical insecticide and a biofertilizer and may further include a binder. The composition provides a natural pesticide defense when introduced at or near the plant rhizosphere, controlling and killing plant pathogenic nematodes and nematode larvae and introducing plant nutrients and growth promoters into the soil to promote water conservation.

This application claims the benefit of priority in U.S. Provisional Patent Appl. Ser. No. 62/492,515 filed on May 1, 2017, the disclosure of which is incorporated herein by reference in its entirety.

### TECHNICAL FIELD

This disclosure relates generally to pesticides. The disclosure relates in particular to a natural, non-hazardous pesticide composition for crops and formulated as a nematicide.

### BACKGROUND OF THE INVENTION

A number of pesticidal formulations, including compositions having one or both of insecticidal and nematicidal properties, are known in the art. Such compositions are typically chemical pesticides such as broad-spectrum toxicants of high volatility or having other properties promoting migration through soil. For example, carbamate insecticides having cholinesterase inhibiting properties, halocarbons, and other chemicals have been used to control nematodes. However, significant safety concerns exist for such chemical pesticides, and indeed many have been disapproved for use/deregistered due to human health, safety, and environmental concerns.

Non-chemical, “natural” approaches such as application of plant-derived nematicidal products, introduction of competitive organisms such as carnivorous fungi, and non-chemical methods of making a pests environment hostile such as soil steaming have been evaluated with varying degrees of success for nematode control. For this reason, alternative compositions having insecticidal/nematicidal properties are of great interest in the industry.

### SUMMARY

In accordance with the foregoing need identified in the art, in one aspect the present disclosure describes a non-hazardous bio-pesticide, nematicide, and plant nutrient composition, comprising a mechanical insecticide and a biofertilizer. The composition may further include a binder. In embodiments, the binder is maltodextrin, the mechanical insecticide is diatomaceous earth, and the biofertilizer comprises a yeast component. The yeast component may be a hydrolyzed brewer's yeast. The diatomaceous earth may be a low bulk density diatomaceous earth. The composition may be formulated in embodiments for application to one or both of a plant and a plant rhizosphere as one or more of a topical application, a soil amendment, a soil spray, and a foliar spray.

In an embodiment, the composition comprises diatomaceous earth in an amount of from about 50% w/w to about 80% w/w, hydrolyzed brewer's yeast in an amount of from about 5% w/w to about 20% w/w, and maltodextrin in an amount of from about 0.25% w/w to about 1% w/w.

In an embodiment, the composition comprises about 80% w/w diatomaceous earth, about 20% w/w hydrolyzed brewer's yeast, and about 1% w/w maltodextrin.

In the following description, there are shown and described embodiments of the disclosed pesticide/nematicide compositions. As it should be realized, the pesticide/nematicid compositions are capable of other, different embodiments and their several details are capable of modification in various, obvious aspects all without departing from the pesticide/nematicide compositions as set forth and described in the following claims. Accordingly, the descriptions should be regarded as illustrative in nature and not as restrictive.

### DETAILED DESCRIPTION

Any citations included or referred to in this application form a part of the disclosure and are incorporated herein in their entirety by reference. It will be appreciated that the embodiments shown and described in this patent application are an illustration of one of the modes best suited to carry out the invention. The invention is capable of other different embodiments, and its several details are capable of modification in various, obvious aspects all without departing from the invention. Accordingly, the drawings and descriptions provided herein will be regarded as illustrative in nature and not as restrictive. Various embodiments of the methods and compositions of the present disclosure will now be described by way of the following Examples.

At a high level, the present disclosure is directed to a natural, non-hazardous pesticidal and nematicidal compositions. The compositions advantageously comprise Environmental Protection Agency (EPA)-approved ingredients determined to be safe for application to crops. Advantageously, in addition to controlling and killing plant pathogenic nematodes and nematode larvae, application of the presently described compositions introduces plant nutrients and growth promoters into the soil, also promoting water conservation. The described compositions provide a natural pesticide defense when introduced into the soil at or near the plant rhizosphere. Embodiments of the described pesticide/nematicide compositions are formulated for application as a foliar and/or soil spray, as a soil amendment, or as a topical application. In embodiments, the disclosed pesticide/nematicide compositions comprise a combination of a mechanical insecticide, a biofertilizer, and a binder.

As is known, a mechanical insecticide does not affect insect or nematode life cycles via chemical, poisonous, or toxicant means. Instead, a mechanical insecticide provides physical modes of action against pests, thus mitigating risk of insecticide resistance. In embodiments, the mechanical insecticide of the present composition is a silicate such as diatomaceous earth. The diatomaceous earth may include a mixture of fine grade and coarse grade diatomaceous earth. As is known, a coarse grade diatomaceous earth has a bulk density of approximately 11 lb/ft³ and a coarse grade diatomaceous earth has a bulk density of about 25 lb/ft³.

Biofertilizers are biologically active derivatives or inoculants of various bacteria, algae, and/or fungi which benefit plant growth by improving or increasing nitrogen and mineral fixation by plants. In embodiments, the biofertilizer of the present composition is a yeast product or derivative, including one or more of live or killed yeast, yeast extract, and yeast residues and byproducts. The biofertilizer may be a by-product of the fermentation industries. In embodiments, the yeast product is a hydrolyzed brewer's yeast comprising a hydrolysate of whole yeast cell, comprising β-glucan, mannans, and oligosaccharides.

In embodiments the binder of the present composition is maltodextrin, which as is known may also possess insecticidal properties.

### Example 1

In an embodiment, the presently described pesticide/nematicide composition comprises from about 50% w/w to about 79% w/w diatomaceous earth, from about 5% w/w to about 20% w/w hydrolyzed brewer's yeast, from about 0.20% w/w to about 1% w/w maltodextrin, and about 0.5% salt.

### Example 2

In an embodiment, the presently described pesticide/nematicide composition comprises about 78% w/w diatomaceous earth, about 20% w/w hydrolyzed brewer's yeast, about 1% w/w maltodextrin, and about 0.5% salt.

### Example 3

A pesticide/nematicide composition according to Examples 1 and 2 was formulated according to the following process. Coarse grade diatomaceous earth was added to a mixer, followed by addition of a 19% maltodextrin solution until a tacky mixture was achieved. Hydrolyzed brewer's yeast was added until fully adsorbed onto the diatomaceous earth, and the mixture was dried to a moisture content of approximately 10%-15%. Following the drying step, a 5% w/w fine grade diatomaceous earth was added to the blend and mixed in the mixer for about 5-15 minutes.

### Example 4

A pesticide/nematicide composition according to Examples 1-3 was provided as a soil amendment by tilling and/or aeration in an amount of from about 1 to about 3 tons per acre. Water was added to activate the applied composition.

### Example 5

A pesticide/nematicide composition according to Examples 1-3 was provided as a topical application by spreading via a conventional fertilizer spreader in an amount of from about 100 to about 300 pounds per 1000 square feet. Water was added to activate the applied composition.

### Example 6

Nematicidal properties of a pesticide/nematicide composition according to Examples 1-3 was evaluated against sting nematode (Belonalaimus longicaudatus). The treatments tested were 2, 200, and 300 lb/1000 ft² of the composition. Sand from greenhouse cultures of sting nematode was used. Plastic pots (9 cm²) were provided with a filter to prevent loss of soil from drain holes. Each treatment was incorporated into soil samples (7 replications) and 200 cm³ of the soil was placed in each pot. Separately raised nematodes were then added (23 nematodes per pot). The pots were then watered (60 ml).

The pots were arranged in a completely randomized design on a lab bench and left for 72 hours. Following the 72 hour exposure of nematodes to the above-listed treatments, the soil was removed from the pots and suspended in water to remove sand. The soil was then sieved (500 mesh sieve) to collect silt and nematodes. The remaining nematodes were washed onto a filter and placed in a mist chamber for 72 hours to allow live nematodes to move through the filter into water for counting. Dead nematodes remained on the filter.

Live nematode counts for each treatment were obtained and analyzed by analysis of variance on untransformed data. The data were also normalized by ln (n+1) transformation. Treatment means for transformed data were separated according to Duncan's multiple-range test (P≤0.05). The results are shown in Table 1.

TABLE 1
Number of sting nematodes (mixed life stages)
recovered/100 cm³ of soil^{a, b}

| | Sting nematodes | Sting nematodes |
|---|---|---|
| Treatment | (untransformed) | ln (n + 1) |
| Untreated | 23 a | 2.99 a |
| 200 lb/1000 ft² | 2 b | 0.95 b |
| 300 lb/1000 ft² | <1 b | 0.40 c |

^{a}Data are means of 7 replications.
^{b}Means followed by common letters are not different (P ≤ 0.05) according to Duncan's multiple-range test.

Advantageously, the pesticide/nematicide provides further desirable properties. In addition to controlling and killing plant pathogenic nematodes and nematode larvae, application of the presently described compositions introduces plant nutrients and growth promoters into the soil, in addition to promoting water conservation. The described compositions further provide a natural pesticide defense when introduced into the soil at or near the plant rhizosphere.

As shown above, the compositions described herein were highly effective against sting nematodes. Accordingly, by the presently described compositions an effective, safe, and non-hazardous nematicide is provided, capable of replacing currently used chemical nematicides and insecticides. The present compositions comprise ingredients already EPA-approved, and in addition to proven insecticidal/nematicidal properties, provide further benefits of including compositions having plant nutrient and growth promoter properties.

While the terms used herein are believed to be well-understood by one of ordinary skill in the art, definitions are set forth to facilitate explanation of certain of the presently-disclosed subject matter.

Following long-standing patent law convention, the terms “a,” “an,” and “the” refer to “one or more” when used in this application, including the claims.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and subcombinations of A, S, C, and O.

The foregoing description of preferred embodiments has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the disclosed subject matter and its practical application to thereby enable one of ordinary skill in the art to utilize the invention in various embodiments and with various modifications as are suited to the particular use contemplated. All such modifications and variations are within the scope of the invention as determined by the claims when interpreted in accordance with the breadth to which they are fairly, legally and equitably entitled.

What is claimed:

1. A non-hazardous bio-pesticide, nematicide, and plant nutrient composition, comprising:
a mechanical insecticide; and
a biofertilizer.

2. The composition of claim 1, further including a binder.

3. The composition of claim 2, wherein the binder is maltodextrin.

4. The composition of claim 1, wherein the mechanical insecticide is a diatomaceous earth.

5. The composition of claim 1, wherein the biofertilizer comprises a yeast component.

6. The composition of claim 5, wherein the yeast component comprises a hydrolyzed brewer's yeast.

7. The composition of claim 4, wherein the mechanical insecticide is a low bulk density diatomaceous earth.

8. The composition of claim 1, formulated for application to one or both of a plant and a plant rhizosphere as one or more of a topical application, a soil amendment, a soil spray, and a foliar spray.

9. The composition of claim 4, comprising diatomaceous earth in an amount of from about 50% w/w to about 80% w/w.

10. The composition of claim 9, comprising about 80% w/w diatomaceous earth.

11. The composition of claim 6, comprising hydrolyzed brewer's yeast in an amount of from about 5% w/w to about 20% w/w.

12. The composition of claim 11, comprising about 20% w/w hydrolyzed brewer's yeast.

13. The composition of claim 3, comprising maltodextrin in an amount of from about 0.25% w/w to about 1% w/w.

14. The composition of claim 13, comprising about 1% w/w maltodextrin.

15. A non-hazardous bio-pesticide, nematicide, and plant nutrient composition, comprising:
from about 50% w/w to about 80% w/w of a diatomaceous earth component comprising a coarse-grade portion and a fine grade portion;
from about 5% w/w to about 20% w/w of a yeast component; and
from about 0.25% w/w to about 1% w/w of a maltodextrin component.

16. The composition of claim 15, wherein the yeast component is a hydrolyzed brewer's yeast.

17. The composition of claim 15, formulated for application to one or both of a plant and a plant rhizosphere as one or more of a topical application, a soil amendment, a soil spray, and a foliar spray.

18. The composition of claim 15, comprising 78% w/w diatomaceous earth.

19. The composition of claim 16, comprising 20% w/w hydrolyzed brewer's yeast.

20. The composition of claim 15, comprising 1% w/w maltodextrin.
